(19) United States
(12) Patent Application Publication
(10) Pub. No.: US 2004/0106085 A1
(43) Pub. Date: Jun. 3, 2004

(54) Dental or medical device

(76) Inventors: Pekka Vallittu, Kuusisto (FI); Lippo Lassila, Turku (FI); llkka Kangasniemi, Turku (FI)

Correspondence Address: James C. Lydon, Suite 100, 100 Daingerfield Road, Alexandria, VA, 22314, US

(21) Appl. No.: 10/720,483

(22) Filed: Nov. 25, 2003

Related U.S. Application Data
(62) Division of application No. 09/972,910, filed on Oct. 10, 2001, now abandoned.

(51) Int. Cl. A61C 13/00

(52) U.S. Cl. 433/167

(57) ABSTRACT

A dental or medical device for use in construction of a finished dental or medical appliance which includes a shapable prepreg, where the prepreg coontains fibers, and at least one solid body attached to the prepreg. The solid body attached to the prepreg constitutes a solid body included in the finished appliance and forms a part or whole of the outer surface of the finished appliance. Also disclosed are methods for the manufacture of the device, either so that the prefabricated solid body is contacted with the prepreg, or so that the solid body is created simultaneously with the manufacturing of the device.

### FIELD OF THE INVENTION

This invention relates to dental or medical devices and to methods for their preparation.

### BACKGROUND OF THE INVENTION

The publications and other materials used herein to illuminate the background of the invention, and in particular, cases to provide additional details respecting the practice, are incorporated by reference.

Fibre-reinforced composites (FRC) are gaining popularity to be used as dental and medical biomaterials. The use of the FRCs in medical and dental applications can be justified by the high strength and biological rigidity of the material. Technological problems in using the FRC with dental and medical resinuous materials, mainly mono or multifunctional acrylates have been overcome by the recent inventions, for example described in U.S. Pat. Nos. 5,846,640 and 6,179,410, relating to the preimpregnation of the fibres with polymers and monomers and their combinations.

The publication The Dental Advisor, vol. 18, no. 7 Sep. 2001 discloses a product DIRECTCROWN™, which is a kit containing crown forms in 16 different sizes, fast-set acrylic resin and dispensing supplies. Crowns of certain desirable shape and size can thus be made. These crowns are, however, not attached to any prepreg.

Although the technological problems of the manufacturing the dental and medical appliances by FRCs are resolved to large extent, some shortcomings still occur in these appliances. One of the shortcomings is difficult shaping the pontic and crown parts of the bridge. Another shortcoming relates to the relatively high wear of the occlusal surfaces of the composite materials as those described in U.S. Pat. No. 4,234,310 or those polymerized by direct technique, i.e. in the patient's mouth. In dental and orthopaedic endosseus implants made of FRCs, there is also need to attach tooth crown, bridge, or artificial joint to the implant.

### SUMMARY OF THE INVENTION

An important property for the dental FRC device from the dentists and dental technicians perspective relates to the fabrication process of the device. The process should allow an effective way to produce FRC devices such as bridges and crowns having veneers and occlusal surfaces of with good esthetic properties and wear resistance. Endosseus implants should contain wear resistance artificial joint surface which can be obtained by the present invention.

One object of the present invention is to make it possible to fabricate FRC appliances from prefabricated devices reputed to have good esthetic properties, wear resistance and fast, easy and cost effective manufacturing procedures.

The object of the invention is to create a medical or dental devices including one or several solid bodies attached to a shapable prepreg. Such devices shall be easy to attach to various frameworks in the manufacture of a final dental or medical FRC appliance.

A particular object of the invention is to create dental devices including one or several solid bodies with the shape of part or the whole occlusal surface or facial veneer of the tooth attached to the same prepreg part. Optionally, to the same prepreg part can also be attached a solid body creating the crestal surface of a pontic.

The solid bodies can form the surface of the tooth in one piece or in several smaller pieces held together by the shapable prepreg. The prepreg shall be easy to place on the FRC framework of the crown or bridge made e.g. with the technique described in U.S. Pat. Nos. 5,846,640 and 6,179,410. After being correctly placed to the occlusion, the resinous matrix of the prepreg shall be polymerizable e.g. by autopolymerization or by light activation.

Thus, according to one aspect, this invention concerns a dental or medical device for use in construction of a finished dental or medical appliance. Said device comprises a shapable prepreg, wherein said prepreg comprises fibers, and at least one solid body attached to said prepreg, wherein said solid body constitutes a solid body included in the finished appliance and forms a part or whole of the outer surface of the finished appliance.

According to another aspect, this invention concerns a method for the manufacturing of a dental or medical device for use in construction of a finished dental or medical appliance, wherein said device comprises a shapable prepreg comprising fibers and a resinous matrix comprising a polymerizable monomer, a polymerizable dendrimer, or a combination thereof, and at least one solid body attached to said prepreg, wherein said solid body constitutes a solid body included in the finished appliance, said method comprising the steps of

contacting the solid body with the prepreg, and

optionally protecting the bottom surface of the prepreg with a protecting tape.

According to yet another aspect, the invention concerns a method for the manufacturing of a dental or medical device for use in construction of a finished dental or medical appliance, wherein said device comprises a shapable prepreg comprising fibers, and at least one solid body attached to said prepreg, wherein said solid body constitutes a solid body in the finished appliance, said method comprising the steps of

adding a mixture of fillers and an uncured resin to an impression formed in a mould, said impression having the shape and size of the solid body to be created,

pressing the fibers against the mould so that the fibers partly penetrate into the mixture in the impression,

curing at least partially the mixture in the impression to create the solid body, and

optionally adding a monomer liquid mixture to the fibers to create the final prepreg (i.e. the prepreg ready for use).

### BRIEF DESCRIPTION OF THE DRAWINGS

FIG. 1 shows a dental device according to the invention, as a perspective view,

FIG. 2 shows a vertical cross section of the device shown in FIG. 1,

FIG. 3 shows a patient's upper and lower tooth arch where a missing tooth in the lower arch has been replaced by use of the device shown in FIGS. 1 and 2,

FIG. 4 illustrates the preparation of the device shown in FIGS. 1 and 2 according to one embodiment,

FIG. 5 illustrates the preparation of the device shown in FIGS. 1 and 2 according to another embodiment,

FIG. 6 illustrates the attachment of the device according to FIGS. 1 and 2, to the framework of a bridge,

FIG. 7 illustrates the preparation of the device according to a further embodiment,

FIG. 8 shows another dental device, bearing several different solid bodies and useful in the construction of a pontic, and

FIG. 9 shows a medical device, useful as a hip prosthesis.

### DETAILED DESCRIPTION OF THE PREFERRED EMBODIMENTS

The prepreg part of the device shall be a shapable prepreg. The wording “shapable prepreg” means that the prepreg shall be easy to bend at low temperatures such as room temperature or human body temperature. Such shapable prepregs are disclosed e.g. in U.S. Pat. No. 6,179,410.

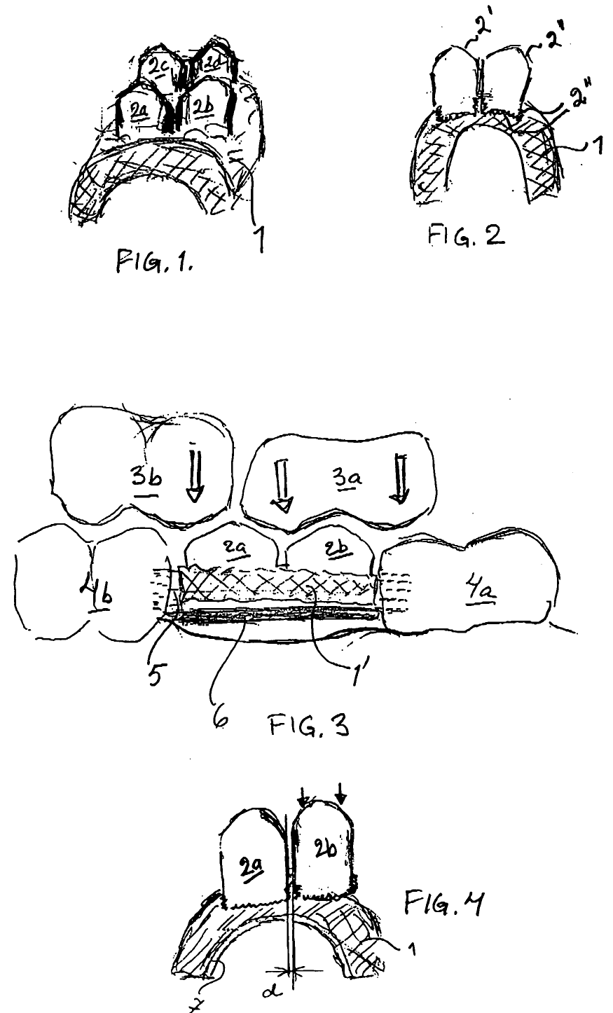

The fibers of the prepreg part of the device can be inorganic or organic fibers or mixtures thereof. As preferable fibers can be mentioned glass fibers, silica fibers or carbon/graphite fibers. The orientation and form of the fibers in the fiber matrix can be either two-dimensional continuous or short fibers depending up to the desired mechanical properties. Three-dimensional chopped glass fibers are preferred due to the possibility to bring the solid body or bodies into good contact with the three-dimensional fiber network. Also the isotropic mechanical properties which are obtained by using the three-dimensional fibers is an advantage. In a dental appliance, a sufficient thickness of the three dimensional fiber product allows penetration of the solid body or bodies (which will create an artificial tooth crown) into the fiber rich phase when upper and lower teeth are in contact to each other (see FIG. 3). The possibility of the individual solid bodies to penetrate in the prepreg part having a sufficient thickness results in a precise occluding contacts of the solid bodies to the opposing teeth.

The prepreg part of the device can comprise either fibers only, fibers and a porous polymer, or fibers embedded in a resinous matrix. The resinous matrix can include a polymerizable monomer, a polymerizable dendrimer, or a combination thereof. Suitable monomers and dendrimer are disclosed e.g. in U.S. Pat. No. 6,197,410. Also polymers can be included in the resinous matrix.

Preferred resinuous materials are, for example, poly-, oligo-, tri-, di- and monomethylmethacrylate, Bis-GMA, TEGDMA, dendrimers and the like. The unpolymerized resinuous matrix may further contain part or all of the polymerization initiators and activators such as camphorquinone, dimethylaminoethylmethacrylate and dimethylparatoluidine.

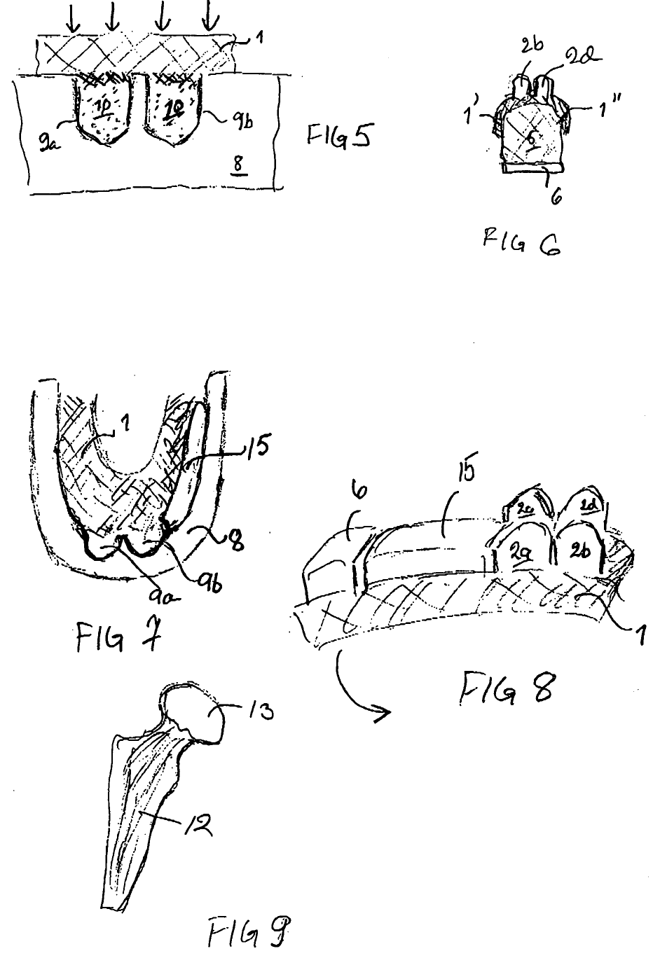

The possibility to use a prepreg part containing no resinous matrix or a prepreg part being only partially impregnated relates especially to the situation where the solid body is manufactured simultaneously with the construction of the device. See e.g. FIG. 5 for details.

The solid body can be made of an inorganic material, an organic material or a combination thereof. For dental applications, the outermost surface (i.e. the part of the surface not contacted with the prepreg) of the solid body (bodies) inluded in the device is preferably made of particulate or fibre filler composite, ceramics, glass or glass-ceramic to the form of facial, buccal, lingual or occlusal surface of the tooth. In the case of abutment of a bridge, the device can also include a solid body forming the crestal surface of the pontic. The solid bodies are embedded into the three-dimensional network of fibres and resinuous matrix. The part of the surface of the solid bodies which is brought into contact with the prepreg is preferably chemically and/or mechanically pre-treated to obtain good bonding of the solid bodies to the prepreg. In the case of composite bodies, this is obtained e.g. by free radical polymerization reaction of the remaining unsaturated functional groups on the surface of the body, or additionally by interdiffusion bonding (interpenetrating polymer networks, IPN), or by using mechanical interlocking of the solid body by means of non-impregnated or partially impregnated fibers. For ceramic or glass bodies, the bonding is preferably obtained by silane coupling agents. Alternatively or additionally, a porous structure of the contact surface of the solid body can be used to facilitate mechanical interlocking between the solid body and the prepreg part.

The outermost layer of the solid body (bodies) intended for an artificial tooth crown is shaped into the form of a whole occlusal surface of the tooth, or into the form of single cusps, or facial veneers or combinations thereof.

In medical devices, the solid body can be formed as an artificial condylar surface of a joint.

The size of the solid body can vary from 0.5 mm to 200 mm depending on the applications. Small size (0.5-50 mm) bodies are used in preferably in dental applications whereas greater bodies (20-200 mm) are preferably used in endosseus implants. As an example of a solid body having a length of about 200 mm can be mentioned the shaft of hip prosthesis.

The device comprising the solid body (bodies) attached to the prepreg will thus form an integral part of a dental or medical FRC appliance with any of the current FRC technologies.

The invention will be illuminated in more detail by referring to the appended drawings.

FIG. 1 is a perspective view of a dental device according to this invention. The device comprises a shapable prepreg part 1, formed as a soft, curved plate or mat, which comprises fibers, preferably three-dimensionally oriented or randomly directed fibers. The fibers may further be embedded in a resinous matrix comprising a polymerizable monomer, a polymerizable dendrimer, or a combination thereof. The prepreg may further comprise a polymer, and furthermore initiators useful in the curing step in the use of the device. Four solid bodies (particles) 2a, 2b, 2c, 2d, which in this case together will form an artificial tooth, are attached to the prepreg part 1.

FIG. 2, which is a vertical cross section of the device in FIG. 1, shows more in detail how the solid bodies 2a . . . 2d are attached to the prepreg plate. The upper free surface 2′ of the bodies 2a . . . 2d will create the cusp of the artificial tooth. The body surface 2″, which is brought into contact with the prepreg 1 is preferably chemically and/or mechanically treated to become porous or rough. Thereby the binding between the contact surface 2″ and the surrounding prepreg 1 is facilitated.

FIG. 3 shows a patient's upper and lower tooth arch where a missing tooth in the lower arch has been replaced by use of the device shown in FIGS. 1 and 2. The patient's own teeth in the upper arch are denoted with reference numbers 3a and 3b and the teeth in the lower arch 4a and 4b. Between the teeth 4a and 4b one tooth is missing. A framework 5 of the pontic, which will constitute a support for the artificial tooth, has been anchored in the adjacent teeth 4a and 4b. This framework 5 can be made of any strong and suitable material, such as metal or ceramics, but preferably it is a fiber reinforced composite. The device in FIG. 1 has been placed on the framework so that the sides 1′ and 1″ (side 1″ not seen in this Figure; FIG. 6 shows this in more detail) of the shapable prepreg 1 has been bent down to follow the surface of the framework. The solid bodies 2a and 2b form part of the artificial tooth crown. The solid bodies 2c and 2d, which remain behind the bodies 2a and 2b, form the remaining part of the artificial crown. The entire pontic including its crestal surface 6, which comes into contact with the patient's gingiva when the pontic is placed in the patient's mouth, and the framework 5 together with the device according to this invention (shown in FIGS. 1-2), can be prefabricated and fixed into the mouth as one single piece. Alternatively, the pontic including its framework 5 and crestal surface 6 may first be fixed in the mouth, and the device according to this invention attached on the framework 5, already fixed into the mouth. The opposing teeth 3a and 3b in the upper arch are aligning the solid bodies precisely. Thereby a good occlusal surface of the artificial tooth is created when the patient clenches his teeth together before the solid bodies are finally positioned in the prepreg during the curing step. The possible clefts remaining between the individual bodies 2a . . . 2d after positioning and polymerization can be filled e.g. with a particulate filler composite material, i.e. with a mixture of fillers and uncured resin material. This composite material is cured in a subsequent step.

According to yet another alternative, the framework 5 can first be placed in the patient's mouth and later be equipped with a device including the tooth forming bodies 2, the facial veneer 15, as well as the body forming the crestal surface 6 of the pontic. Such a device is shown in FIG. 8.

FIG. 6 is a cross section of the pontic comprising the framework 5 and the crestal surface 6. The framework 5 of the bridgework is preferably made of continuous unidirectional or woven glass fiber prepregs as described in the U.S. Pat. Nos. 5,846,640 and 6,179,410. The device including the solid bodies attached to the prepreg is placed on the framework 5. This figure shows that both sides 1′ and 1″ of the shapable prepreg plate 1, bearing the solid bodies of which only 2b and 2d can be seen, are curved so as to follow the surface of the framework 5, so that side 1′ will create the buccal surface and side 1″ the palatal surface of the pontic. Before curing (e.g. by light polymerization), the solid bodies are aligned to precisely to the occlusion by biting upper and lower teeth together (see FIG. 3). The resinous phase of the prepreg is now polymerized and the solid bodies are bonded and mechanically interlocked to the three dimensional network of the glass fibers in the prepreg. The clefts between the solid bodies 2 are later filled, e.g. with restorative composite resin.

FIG. 4 illustrates the preparation of the device for use on a pontic of a dental bridge, said device shown in FIGS. 1 and 2. In this alternative, the solid bodies (of which 2a and 2b are seen in the Figure), have been prefabricated before they are pressed into the shapable prepreg plate 1. The bodies 2a . . . 2d have been made in the shape and colour of the cusp of the tooth, using dental ceramics or particulate filler/fibre composites. The surface of the bodies brought into contact with the prepreg plate, i.e. the contact surface 2″, is preferably chemically treated (with silane coupling agents, preferably gamma-propyltrimetoxysilane) and/or mechanically roughened for good adhesion and interlocking of the solid bodies to the resinuous part of the prepreg 1.

The fiber product of the prepreg is preferably a three dimensional shopped strand mat (thickness about 1.0-10 mm) of glass fibers treated with a silane coupling agent. This chopped strand mat is preferably impregnated with nonpolymerized resinuous monomers, dendrimers or with highly viscous monomer-polymer gel, for example as described in U.S. Pat. No. 6,197,410. The resinous matrix, e.g. the impregnation polymer, contains preferably the chemicals required for the subsequent polymerization of the resinous matrix by light, microvawe, heat, etc. initiator means.

The individual solid bodies 2a . . . 2d are pressed into the prepreg 1 with an internal distance d being suitably about 0.1-2.0 mm. The resinous matrix together with the fibers of the prepreg 1 keep the solid bodies 2a . . . 2d effectively enough attached before the curing is performed in the use of the device.

The bottom of the prepreg 1 can optionally be protected by a tape 7 before the device is used.

FIG. 5 illustrates the preparation of the device shown in FIGS. 1 and 2 according to an alternative method. In this method, the solid bodies are manufactured simultaneously with the device. The method comprises the following steps:

1. A mixture 10 of fillers and an uncured resin is added into impressions 9a . . . 9b (the two remaining impressions are not shown) formed in a mould 8, which preferably is made of a material transparent to curing light. Said impressions have the shape and size of the solid bodies to be created.

2. The prepreg 1, which according to one alternative may comprise fibers only, is pressed against the mould so that the fibers of the prepreg partly penetrate into the mixture 10 in the impressions 9a . . . 9b.

3. The mixture 10 is cured, e.g. by light, wherein said mixture is converted into the solid bodies.

The fibers that had penetrated into the upper layer of the mixture 10 are strongly attached to the solid body as a result of the curing step of the mixture. Therefore it is not necessary to have any resinous matrix in the prepreg before the pressing step. Before such a device is used, the prepreg 1 shall of course be impregnated with a polymerizable monomer or dendrimer or mixture thereof. The prepreg can further also be impregnated with a polymer and/or the necessary initiators for the curing step in the use of the device.

The fibers of the prepreg used in this method are preferably three-dimensionally oriented or randomly directed. The fibers can, according to one alternative, also be partly impregnated with a polymerizable monomer or dendrimer or mixture thereof, before the prepreg is pressed against the mold. It is important that the prepreg is not fully impregnated if the polymerizable monomer or dendrimer will also polymerize during the curing step by light activation. In order to be shapable, the prepreg shall have capacity to take up further monomer or dendrimer after curing the mixture 10 into solid bodies. The prepreg may be fully impregnated in case the solid body is cured chemically.

FIG. 7 illustrates the preparation of the device according to still further alternatives. Impressions (9a, 9b . . . ) corresponding to the size and shape of the solid bodies 2 are made in a curved mold 8 made of silicone, preferably an elastic and soft silicone which most preferably is transparent to curing light. Such silicones are described e.g. in the International Patent Publication No. WO 01/50979. The prefabricated solid bodies 2 (not shown in the Figure) are placed into the impressions 9. Then the prepreg 1 is placed in the mold. The prepreg 1 and the mold 8 are pressed against each other and the solid bodies are partly pressed into the prepreg layer. The mold can also, for example, have cavities for other solid bodies. The Figure illustrates a situation where the facial veneer 15 in the same way can be attached to the prepreg 1. The silicone mold 8 can be retained around the device until the device is used.

The solid bodies can alternatively be created in the impressions in the silicone mold by filling said impressions a mixture of fillers and uncured resin. In this case the solid bodies are created simultaneously with the device according to the method shown earlier in FIG. 5.

FIG. 8 shows a dental device, useful in the construction of a pontic. The prepreg 1 bears the solid bodies 2a . . . 2d forming the artificial tooth crown. In addition hereto, the prepreg bears a solid body 6, which will create the crestal surface 6 of the pontic when the shapable prepreg 1 is wrapped around the framework 5 (framework 5 shown in FIG. 6) of the pontic so that the body 6 is positioned downwards and the solid bodies 2a . . . 2d upwards. The prepreg 1 bears also a body denoted 15, which creates the facial veneer of the tooth when the device has been placed on the framework.

FIG. 8 shows a medical device useful as hip prosthesis. The prepreg 12 bears a solid body 13 which has the shape and size of a condyle for an artificial joint. The prepreg part is preferably coated with a suitable material before use.

Because the solid bodies are part of the device, they can be easily placed to the desired region on the FRC framework of the bridge or crown or other framework made using the state-of-the-art FRC technique.

This invention enables the manufacturing of a strands of prepregs, where each prepreg bears one crown for a certain tooth. The different prepregs can thus be arranged after each other to form a strand corresponding to the teeth in the upper jaw as well or the lower jaw. The user can thus select a the part of the strand (comprising one or several teeth) for use. The cut-off lines between the individual prepregs can be marked so as to facilitate that the user's work. Alternatively, all the crowns for the teeth in the upper or lower jaw can be arranged on the same prepreg piece.

It will be appreciated that the methods of the present invention can be incorporated in the form of a variety of embodiments, only a few of which are disclosed herein. It will be apparent for the expert skilled in the field that other embodiments exist and do not depart from the spirit of the invention. Thus, the described embodiments are illustrative and should not be construed as restrictive.

We claim:

1. A dental or medical device for use in construction of a finished dental or medical appliance, said device comprising a shapable prepreg, wherein said prepreg comprises fibers, and at least one solid body attached to said prepreg, wherein said solid body constitutes a solid body included in the finished appliance and forms a part or whole of the outer surface of said finished appliance.

2. The device according to claim 1, wherein the solid body is made of an organic material, an inorganic material or a combination thereof.

3. The device according to claim 1 wherein the prepreg comprises inorganic or organic fibers of mixtures thereof, said fibers being embedded in a resinous matrix comprising a polymerizable monomer, a polymerizable dendrimer, or a combination thereof.

4. The device according to claim 3 wherein the prepreg further comprises a polymer.

5. The dental device according to claim 1 wherein the solid body has the shape of a tooth crown, and the prepreg is shaped as a plate and comprises three-dimensionally oriented or randomly directed fibers.

6. The dental device according to claim 1 wherein several individual, preferably four, solid bodies are attached close to each other into the prepreg, wherein said bodies are attached so as to form cusps of a tooth to be constructed.

7. The dental device according to claim 6 wherein the prepreg is shaped as a plate and comprises three-dimensionally oriented or randomly directed fibers.

8. The dental device according to claim 7 wherein said prepreg comprises inorganic or organic fibers of mixtures thereof, said fibers being embedded in a resinous matrix comprising a polymerizable monomer, a polymerizable dendrimer, or a combination thereof.

9. The device according to claim 8 wherein the prepreg further comprises a polymer.

10. Medical device according to claim 1 wherein the solid body has the shape and size of a condyle for an artificial joint.

11. Method for the manufacturing of a dental or medical device for use in construction of a finished dental or medical appliance, wherein said device comprises a shapable prepreg comprising fibers and a resinous matrix comprising a polymerizable monomer, a polymerizable dendrimer, or a combination thereof, and at least one solid body attached to said prepreg, wherein said solid body constitutes a solid body included in the finished appliance, said method comprising the steps of
contacting the solid body with the prepreg, and
optionally protecting the bottom surface of the prepreg with a protecting tape.

12. The method according to claim 11 wherein the part of surface of the solid body, which is contacted with the prepreg, has been chemically and/or mechanically pre-treated so as to facilitate good contact with the prepreg.

13. The method according to claim 12 wherein the prepreg also comprises a curable polymer.

14. The method according to claim 13 wherein the prepreg also comprises the necessary initiators for the curing step in the use of the device.

15. The method according to claim 11 where the solid body or bodies is first placed in impressions made in a mold of silicone after which the prepreg and mold are pressed towards each other so that the solid body or bodies are partly pressed in the prepreg.

16. The method according to claim 15 where the mold is retained around the device until the use of said device.

17. Method for the manufacturing of a dental or medical device for use in construction of a finished dental or medical appliance, wherein said device comprises a shapable prepreg comprising fibers, and at least one solid body attached to said prepreg, wherein said solid body constitutes a solid body in the finished appliance, said method comprising the steps of
adding a mixture of fillers and an uncured resin into an impression formed in a mould, said impression having the shape and size of the solid body to be created,
pressing the fibers against the mould so that the fibers partly penetrate into the mixture in the impression,
curing at least partially the mixture in the impression to create the solid body, and
optionally adding a monomer liquid mixture to the fibers to create the final prepreg.

18. The method according to claim 17 wherein the prepreg of the device subsequently is impregnated with a polymerizable monomer or dendrimer or mixture thereof.

19. The method according to claim 17 wherein the prepreg subsequently also is impregnated with a polymer and/or the necessary initiators for the curing step in the use of the device.

20. The method according to claim 17 wherein the fibers of the prepreg are three-dimensionally oriented or randomly directed and that said fibers are partly impregnated with a polymerizable monomer or dendrimer or mixture thereof, before the steps of claim 17 is carried out.

21. The method according to claim 17 wherein the mold is made of silicone and said mold is retained around the device until the use of said device.
